(19) United States
(12) Patent Application Publication
(10) Pub. No.: US 2024/0169194 A1
(43) Pub. Date: May 23, 2024

(54) TRAINING NEURAL NETWORKS FOR NAME GENERATION

(71) Applicant: Salesforce, Inc., San Francisco, CA (US)

(72) Inventor: Michael Sollami, Cambridge, MA (US)

(21) Appl. No.: 17/989,871

(22) Filed: Nov. 18, 2022

(51) Int. Cl. G06N 3/08; G06F 40/279; G06F 40/40; G06N 3/04

(52) U.S. Cl. CPC G06N 3/08; G06F 40/279; G06F 40/40; G06N 3/0454

(57) ABSTRACT

Systems, device and techniques are disclosed for training neural networks for name generation. A target set including words associated with an object type may be received. A discriminator network and a generator network may be trained. The discriminator network may be trained with a training data set that is based on the target set and the generator network may be trained with random inputs and the discriminator network. The discriminator network may be trained for two epochs for each epoch for which the generator network is trained. The generator network may generate words.

### BACKGROUND

Generating appropriate names for named objects may be difficult and time consuming. Persons responsible for the creation of objects that need to be named, such as businesses, products, and research papers, may not be skilled in the generation of names. This may result in such persons either devoting additional time and effort to generating names that they could use to better effect elsewhere, or may result in the generation of names being outsourced to other persons who were not involved with the creation of the object that needs to be named, adding expenses.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example system for training neural networks for name generation according to an implementation of the disclosed subject matter.

FIG. 2 shows an example arrangement for training neural networks for name generation according to an implementation of the disclosed subject matter.

FIG. 3 shows an example arrangement for training neural networks for name generation according to an implementation of the disclosed subject matter.

FIG. 4A shows an example arrangement for training neural networks for name generation according to an implementation of the disclosed subject matter.

FIG. 4B shows an example arrangement for training neural networks for name generation according to an implementation of the disclosed subject matter.

FIG. 5 shows an example arrangement for training neural networks for name generation according to an implementation of the disclosed subject matter.

FIG. 6 shows an example procedure suitable for training neural networks for name generation according to an implementation of the disclosed subject matter.

FIG. 7 shows an example procedure suitable for training neural networks for name generation according to an implementation of the disclosed subject matter.

FIG. 8 shows an example procedure suitable for training neural networks for name generation according to an implementation of the disclosed subject matter.

FIG. 9 shows a computer according to an implementation of the disclosed subject matter.

FIG. 10 shows a network configuration according to an implementation of the disclosed subject matter.

### DETAILED DESCRIPTION

Techniques disclosed herein enable training neural networks for name generation, which may allow for the generation of words that may be used as names for objects of a specified object type. A target set including words associated with a selected object may be received. A discriminator network and a generator network may be trained. The discriminator network may be trained with a training data set that is based on the target set and the generator network may be trained with random inputs and the discriminator network. The discriminator network may be trained for two epochs for each epoch for which the generator network is trained. Output words may be generated with the generator network. Guiding metadata for the generator network may be received. During training of the discriminator network and the generator network, the guiding metadata may be used in evaluation of the generator network. Before training the discriminator network and the generator network, the discriminator network may be initialized with weights that preserve variance and the generator network may be initialized with weights that are orthogonal matrices.

A target set including words associated with a selected object may be received. The words for the target set may be gathered by scraping websites and using named entity recognition. The words gathered for the target set may be words that are related to a goal output of the generator network that will be trained using a discriminator network that is trained using words from the target set. The goal output may be based on user input of an object type for an object the generator network will be used to generate a name for. For example, the object may be a business artifact, such as business, product, product feature, business unit, or project, may be a research paper, an API service, model or simulation, or any other such object. The user may specify the object type, and words that are associated with that object type may be gathered. For example, if the user specifies that the object type of the object to be named is a business, the names of businesses may be gathered by scraping websites to gather names of already existing businesses using named entity recognition. The gathered business names may be used as words of the target set. The websites that are scraped may be related to the object type. For example, if the object is a research paper, research paper names may be scraped from websites that host research papers, or index titles of research papers, and used as words of the target set. The object type may include any suitable level of specificity. For example, if the object is a technology business, the words gathered for the target set may be the names of technology businesses instead of the names of all types of businesses. Any suitable number of words may be gathered for the target set. The degree of specificity the object type may be prescribed by, for example, a user interface used to input the object type. For example, a user may be presented with preset object types that the user may select from to specify the object type of the object they want to generate a name for.

The words of the target set may be modified in any suitable manner to make them suitable for use in training neural networks. For example, the words may be padded so that each word in the training data set is the same length, which may be a maximum length set for the target set. The maximum length may be, for example, a maximum length desired for the name that will be generated. The words may be padded using any suitable character.

A discriminator network and a generator network may be trained. The discriminator network and the generator network may be separate neural networks that may have any suitable architectures. The discriminator network may, for example, include a first fully connected layer connected to a second fully connected layer using a leaky rectified linear unit for activation, the second fully connected layer connected to a third fully connected layer using a leaky rectified linear unit for activation, and the third fully connected layer connected to the output of the discriminator network through a reshape layer and a sigmoid function for activation. The generator network may, for example, include a first fully connected layer connected to a second fully connected layer through a reshape layer using a leaky rectified linear unit for activation, the second fully connected layer connected to a third fully connected layer through a reshape layer using a leaky rectified linear unit for activation, the third fully connected layer connected to a fourth fully connected layer through a reshape layer using a leaky rectified linear unit for activation, and the fourth fully connected layer connected to the output of the generator network through a reshape layer using leaky rectified linear unit that output to a sigmoid function for activation.

A hyperparameter search may be initiated to determine the latent dimension sizes for the generator and discriminator networks. The hyperparameter search may, for example, compare the results of using the target set to train versions of the discriminator and generator networks various sets of dimension sizes and selecting the dimension sizes that produce the best results.

The discriminator network may be initialized with dimensions taken from one of the sets of dimension sizes that will be used in the hyperparameter search and weights that preserve the variance of the arrays of the discriminator network when input is propagated through the layers of the discriminator network. For example, the weights of the discriminator network may be initialized using random values. The generator network may be initialized dimensions taken from one of the sets of dimension sizes that will be used in the hyperparameter search and with weights that are selected to be orthogonal matrices.

The discriminator network may be trained with a training data set that is based on the target set and the generator network may be trained with random inputs and the discriminator network. The training data set for the discriminator network may be generated using words from the target set. Words from the target set, as positive examples, may be mixed with words that are not part of the target set and would not belong in the target set, as negative examples, within the training data set. This may allow the training data set to be used to train the discriminator network to be trained to distinguish between words that belong to the target set and words that would not belong to the target set. A word from the training data set may be input to the discriminator network which may output a determination, which may be a binary indicator or a probability of confidence level, of whether the word belong to the target set. The loss of the discriminator network may be based on, for example, the accuracy of the determinations output by the discriminator network for input words from training data set. In some implementations, the discriminator network may be evaluated using Jensen-Shannon divergence during training of the discriminator network. The loss may be used to train the discriminator network, for example, adjusting the weights of the discriminator network. This may train the discriminator network to distinguish between words that belong to the target set and words that would not belong to the target set. The discriminator network may be trained using any suitable training algorithm, such as, for example, stochastic gradient descent, adaptive gradient algorithm, root mean square propagation, or Adam.

The generator network may be trained by inputting random variates of a normal distribution to the generator network resulting in the generation of words by the generator network. The words generated by the generator network may be evaluated using the discriminator network to determine whether the discriminator network classifies the words as belonging to the target set. The loss of the generator network may be based on, for example, whether words generated by the generator network are classified by the discriminator network as belonging to the target set if the output of the discriminator network is a binary indication, or may be based on the individual or cumulative probabilities or confidence levels assigned to the words by the discriminator network. The loss may be used to train the generator network, for example, adjusting the weights of the generator network. This may train the generator network to generate words that are not already in the target set but appear to the discriminator network as if they belong to the target set. The generator network may be trained using any suitable training algorithm, such as, for example, stochastic gradient descent, adaptive gradient algorithm, root mean square propagation, or Adam.

The discriminator network may be trained for two epochs for each epoch for which the generator network is trained. A training epoch for the discriminator network may include training the discriminator network using any suitably sized subset of the words in the training data set, which may include both words from the target set and words that are not in the target set. A training epoch for the generator network may include the generation and evaluation of any suitable number of output words from any suitable number of random inputs to the generator network.

Any suitable number of versions of the discriminator network and generator network may be trained using the training data set that is based on the target set, for example, based on the settings of the hyperparameter search. For example, the hyperparameter search may evaluate 30 different latent dimension size combinations for the discriminator network and the generator network, resulting in the training of 30 different versions of the discriminator network and generator network in order to determine which latent dimension sizes produce the best results. The hyperparameter search may determine which latent dimension sizes produce the best results in any suitable manner, based on any suitable criteria, such as, for example, accuracy of the discriminator network on the training data set and percentage of words output by the generator network that the discriminator network classifies as belonging to the target set.

Output words may be generated with the generator network. The generator network, using the dimensions sizes and weights from the version of the generator network that was part of the combination discriminator network and generator network versions that produced the best results during the hyperparameter search may be used to generate words. Any suitable number of random variates of a normal distribution may be input to the generator network, resulting in the generator network generating an equivalent number of words. The words may be candidates to be used as the name for the object that the generator network was trained to generate a name for. The words output by the generator network may be evaluated in any suitable manner, for example, by a party responsible for assigning a name to the object that the generator network was trained to generate names for.

If the generator network does not generate any words that are evaluated to be a suitable name for the object, the generator network and discriminator network may undergo further training. The training data set may be modified before being used in further training, for example, by adding new words to the target set, removing words from the target set, adding more words that are not part of target set, or removing words that are not part of the target set. The hyperparameter search may be continued using previously unused dimensions sizes to train additional versions of the discriminator network and generator network until, for example, dimension sizes that produce better results than the dimension sizes that were determined to produce the best results during the preceding hyperparameter search. This may be repeated until, for example, the user indicates the generator network has generated a suitable name for the object.

Guiding metadata for the generator network may be received. Guiding metadata may be metadata that indicates preferred properties of the words generated by the generator network in addition to the word being a suitable name for objects that have the object type of the object being named. The guiding metadata may include, for example, topics that the generated words should be related to, sectors, such as business sectors, that the generated words should be related to, target lengths for the generated words, whether the generated words should read as formal or informal, and what time period the generated words should appear to be from, including the possibility of “futuristic” words along with “past” words and “modern” words. The guiding metadata may include any number of properties for a word and may specify associated options for each included property. A property may have any number of options that may be selected from. The options for a property may be discrete, for example, selecting a specific sector that a word should be related to, or may be based on scale, for example, from “past” to “futuristic” with any suitable number of intervals in between for selecting the time period a word should appear to be from. The guiding metadata for the generator network may be received as input from a user, who may use the guiding metadata to further customize the words generated by the generator network. For example, if the object to be named is a company, guiding metadata may be input to customize the generated words that may be used as the company name to be related to the technology and to appear to be “futuristic.” The guiding metadata may be received as input from a user based on options presented to the user. For example, the user may be presented with all of the available properties and may select from among the options for any number of the properties.

A Natural Language Processing (NLP) transformer may be trained to classify the style of words to allow for the guiding metadata to be used in the generation of words by the generator network. The NLP transformer may be a transformer using any suitable architecture that may be trained to classify the style of words according to the various properties and their associated options that will be used as guiding metadata. For example, the NLP transformer may be trained to classify words based on sectors, such as business sectors, the words may be related to, topics that words may be related to, whether a word reads as formal or informal, and what time period a word appears to be from. The properties and associated options presented to a user for entering guiding metadata may be based on the classifications that the NLP transformer has been trained to performed. For example, if the NLP transformer has been trained to classify words as belonging to any of 20 different sectors, the user may be presented with an option to select any of these 20 sectors as guiding metadata.

During training of the discriminator network and the generator network, the guiding metadata may be used in evaluation of the generator network. The guiding metadata may be used in any suitable manner. For example, the NLP transformer may be used to determine which words gathered for the target set match the guiding metadata, with words that do not match the guiding metadata being discarded from the target set. This may result in the words from the target set that are used in the training data set not only being appropriate to the object type of the object being named, but also being representative of words that match the guiding metadata. The NLP transformer may be used to determine which words generated by the generator network match the guiding metadata during training of the generator network. For example, during training of the generator network, words generated by the generator network that are classified by the discriminator network as belonging to the target set may then be evaluated using the NLP transformer to determine if the words match the guiding metadata, or the NLP transformer may be used to determine if the words match the guiding metadata before the words are input to the discriminator network. Words that do not match the guiding metadata may contribute to the loss of the generator network. The NLP transformer may be used to determine which words generated by the generator network match the guiding metadata after training of the generator network. Once the generator network has been trained, words output by the generator network may be checked using the NLP transformer, and only those words that match the guiding metadata may be presented as possible names for the object that generator network was trained to generator a name for.

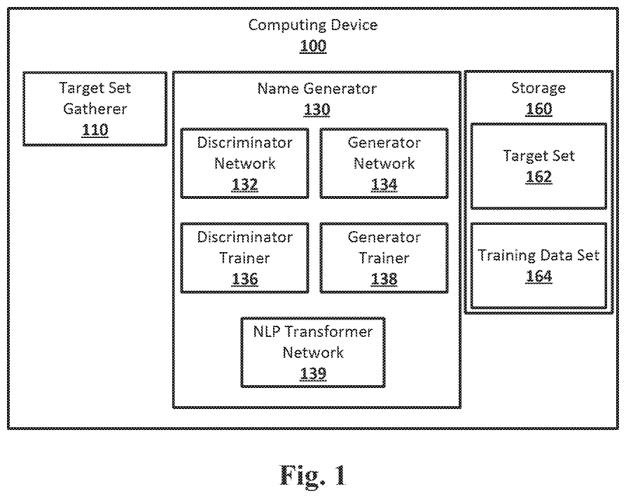

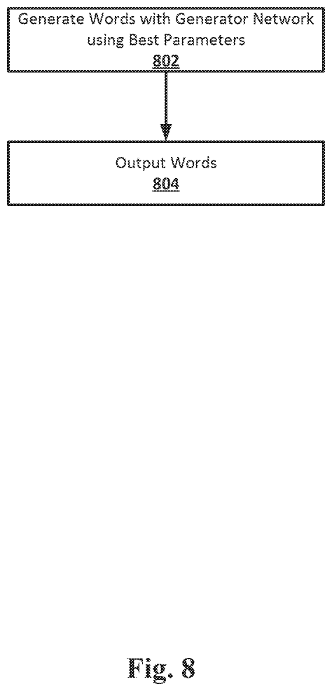

FIG. 1 shows an example system for training neural networks for name generation according to an implementation of the disclosed subject matter. A computing device 100 may be any suitable computing device, such as, for example, a computer 20 as described in FIG. 9, or component thereof, for training neural networks for name generation. The computing device 100 may include a target set gatherer 110, name generator 130, and storage 160. The computing device 100 may be a single computing device, or may include multiple connected computing devices, and may be, for example, a laptop, a desktop, an individual server, a server cluster, a server farm, or a distributed server system, or may be a virtual computing device or system, or any suitable combination of physical and virtual systems. The computing device 100 may be part of a computing system and network infrastructure, or may be otherwise connected to the computing system and network infrastructure, including a larger server network which may include other server systems similar to the computing device 100. The computing device 100 may include any suitable combination of central processing units (CPUs), graphical processing units (GPUs), and tensor processing units (TPUs).

The target set gatherer 110 may be any suitable combination of hardware and software of the computing device 100 for gathering words. The target set gatherer 110 may, for example, access the Internet through any suitable network connection, access websites, and scrape words from the websites. The target set gatherer 110 may, for example, use named entity recognition. The words gathered by the target set gatherer 110 may be used to generate a target set 162. The words gathered by the target set gatherer 110 may be words that are related to a goal output of the name generator 130. The goal output may be specified by, for example, user input, and be based on an object type of an object that the user wants the generator network to be trained to generate a name for. For example, the object may be a business artifact, such as business, product, product feature, unit, or project, may be a research paper, an API service, a model or simulation, or any other such object. The target set gatherer 110 may gather words associated with the object type of the object specified by the user, for example, words that are already names for objects of that object type. The target set gatherer 110 may gather any suitable number of words for the target set 162. The words for the target set 162 may be stored in any suitable manner in the storage 160. The target set gatherer 110 may gather words for a new target set, such as the target set 162, for every distinct object that a user wants to generate a name for.

The name generator 130 may be any suitable combination of hardware and software of the computing device 100 for implementing a name generator using neural networks. The name generator 130 may include, for example, a discriminator network 132, a generator network 134, a discriminator trainer 136, a generator trainer 138, and an NLP transformer network 139. The discriminator network 132 of the name generator 130 may be a machine learning model, such as a convolutional neural network with any suitable number of layers connected in any suitable manner by any suitable number of weights any suitable activation functions. The discriminator network 132 may be trained using words from a training data set 164 which may include words from the target set 162 and words that would not belong to the target set 162. The discriminator trainer 136 may train the discriminator network 132 using, for example, stochastic gradient descent, adaptive gradient algorithm, root mean square propagation, or Adam.

The generator network 134 may be a machine learning model, such as a neural network, that may be trained to output words that may be considered by the discriminator network 132 to belong to the target set 162 although they may not actually be in the target set 162. The generator network 134 may use random variates of a normal distribution as input. During training of the generator network 134, the discriminator network 132 may be used to determine whether the words output by the generator network 134 are or are not considered by the discriminator network 132 to be words that could belong to the target set 162 and the NLP transformer network 139 may be used to determine whether the words output by the generator network 134 match the guiding metadata that may have been input by a user. The generator trainer 138 may train the generator network 134 using, for example, stochastic gradient descent, adaptive gradient algorithm, root mean square propagation, or Adam.

The NLP transformer network 139 may be a transformer network using any suitable architecture that may be trained to classify the style of words according to the various properties that will be used as guiding metadata. For example, the NLP transformer network 139 may be trained to classify words based on sectors, such as business sectors, the words may be related to, topics that words may be related to, whether a word reads as formal or informal, and what time period a word appears to be from. The options presented to a user for entering guiding metadata may be based on the classifications that the NLP transformer network 139 has been trained to perform. For example, if the NLP transformer network 139 has been trained to classify words as belonging to any of 20 different sectors, the user may be presented with an option to select any of these 20 sectors as guiding metadata. The NLP transformer network 139 may have been trained in any suitable manner to perform classification on any suitable number of properties of words with any suitable number of options.

The storage 160 may be any suitable combination of hardware and software for storing data. The storage 160 may include any suitable combination of volatile and non-volatile storage hardware and may include components of the computing device 100 and hardware accessible to the computing device 100, for example, through wired and wireless direct or network connections. The storage 160 may store the target set 162 and the training data set 164. The training data set 164 may be a set of words used to train the discriminator network 132 and may include words from the target set 162 as positive examples and words that would not belong in the target set 162 as negative examples. An answer key may indicate which words in the training data set 164 are positive examples and which are negative examples.

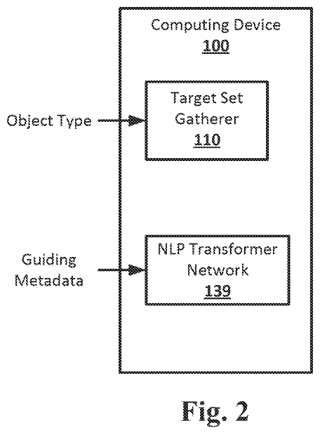

FIG. 2 shows an example arrangement for training neural networks for name generation according to an implementation of the disclosed subject matter. The computing device 100 may receive an indication of an object type and guiding metadata, for example as input from a user. The object type may be an indication of the type of the object that the name generator 130 will be used to generate a name for. For example, the object may be a business artifact, such as business, product, product feature, unit, or project, a research paper, an API service, a model or simulation, or any other such object that may need to be named. The object type may be specified with any suitable degree of specificity. For example, an object that is a business may be specified with an object type of business or may be specified as business within a certain sector, such as technology business. The indication of the object type may be received at the target set gatherer 110. The guiding metadata may be additional stylistic criteria that may be used in the generation of names for the object of the received object type. The guiding metadata may be used, for example, by a user, to specify stylistic preferences for the words generated using the name generator 130. The guiding metadata may include, for example, topics that the generated words should be related to, sectors, such as business sectors, that the generated words should be related to, target lengths for the generated words, whether the generated words should read as formal or informal, and what time period the generated words should appear to be from, including the possibility of “futuristic” words along with “past” words and “modern” words. The guiding metadata may include selected options for any number of properties that the NLP transformer network 139 has been trained on for the classification of words. The guiding metadata may be received at the NLP transformer network 139.

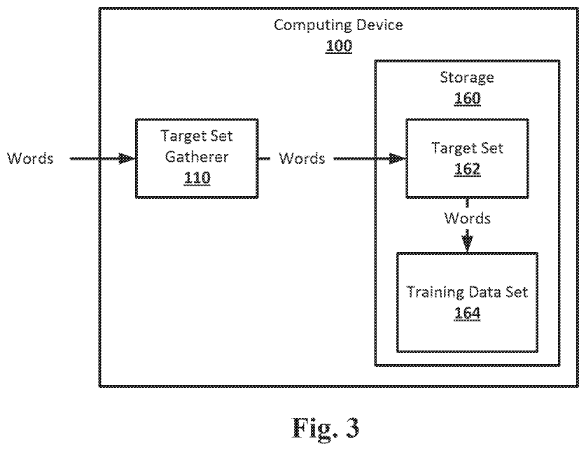

FIG. 3 shows an example arrangement for training neural networks for name generation according to an implementation of the disclosed subject matter. The target set gatherer 110 may receive words. The words may be names of objects of the same object type as the object type received by the target set gatherer 110 from, for example, user input, and may be obtained by the target set gatherer 110 in any suitable manner. For example, the target set gatherer 110 may visit websites on the Internet and scrape words from the websites, for example, using named entity recognition to recognize words that are names of objects of the appropriate object type. The target set gatherer 110 may determine which websites to visit and obtain words from in any suitable manner. For example, the target set gatherer 110 may be provided with a list of websites, for example, websites that are considered to be related to the received object type. For example, if the object type is “business”, the target set gatherer 110 may use a list of websites that are either business websites, business directories, or would otherwise be known to include business names to determine which websites to scrape words from. If the object type is “research paper”, the target set gatherer 110 may use a list of websites that host research papers or are indexes or lists of research papers.

The words received at the target set gatherer 110 may be stored as the target set 162. The target set 162 may include words that are names of objects that are of the same object type as the receive object type. The words from the target set 162 may be used to generate the training data set 164. For example, the training data set 164 may include the words from the target set 162 and words from any other suitable source that are words that would not belong to the target set 162, such as, for example, words that are names for objects of a different type than the received object type. The words from the target set 162 may serve as positive examples in the training data set 164 and the words that would not belong to the target set 162 may serve as negative examples in the training data set 164. The negative examples may be taken from target sets that the target set gatherer 110 generated for previously received object types that are different from the received object type for which the target set 162 was generated. For example, if the received object type is “business”, the negative examples in the training data set 164 may be taken from target sets that were generated for other object types such as research papers, models, or simulations. The training data set 162 may also include an answer key which indicates which words in the training data set 162 are positive examples, having come from the target set 162, and which are negative examples, having not come from the target set 162.

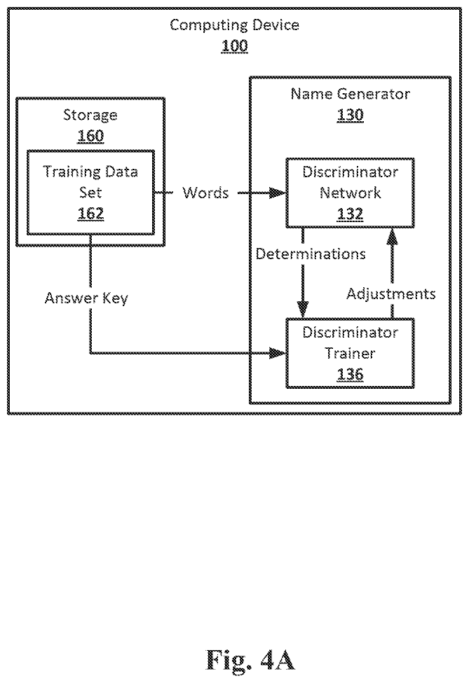

FIG. 4A shows an example arrangement for training neural networks for name generation according to an implementation of the disclosed subject matter. Words from the training data set 164 may be input to the discriminator network 132 of the name generator 130. The words may be converted into a feature vector format before being input to the discriminator network 132. For each input word, the discriminator network 132 may output a determination of whether the word is from the target set 162. The determination may be output from the discriminator network 132 to the discriminator trainer 136. The discriminator trainer 136 may also receive the answer key from the training data set 164. Determinations output by the discriminator network 132 may be binary determinations, for example that the word either does or does not belong to the target set, or may be a probability or confidence level that the word belongs to the target set that may be between 0% and 100%.

The discriminator trainer 136 may compare the determination received from the discriminator network 132 based on the input of a word from the training data set 164 to the answer from the answer key for that word from the training data set 164 to determine the correctness of the determination. For example, if the discriminator network 132 outputs a determination that the word is from the target set 162 and the answer from the answer key for the word indicates that the word is a positive example, being from the target set 162, then the discriminator trainer 136 may determine that the determination output by the discriminator network 132 was correct. Similarly, a determination that a word is not from the target set 162 may be determined to be correct when the answer in the answer key for the word indicates that the word is a negative example, not being from the target set 162. If the discriminator network 132 outputs probabilities or confidence levels, the discriminator trainer 136 may either force the probabilities or confidence levels to 0 or 1 through rounding, or may evaluate the correctness of the discriminator network 132 based on how close the probability or confidence level for a word was to the correct binary value for that word based on the answer key. The discriminator trainer 136 may adjust the weights of the discriminator network 132 based on whether the discriminator network 132 makes correct or incorrect determinations for words input from the training data set 164. This may train the discriminator network 132 to discriminate between words that should belong to the target set 162, which may be words that are suitable names for the object type that the name generator 130 will be used to generate names for, and words that should not belong to the target set 162, which may be words that are not suitable names for the object type that the name generator 130 will be used to generate names for. The training of the discriminator network 132 with the discriminator trainer 136 may use, for example, stochastic gradient descent, adaptive gradient algorithm, root mean square propagation, or Adam.

Any number of words from the training data set 164 may be input to the discriminator network 132 of the name generator 130, over any suitable period of time, to train the discriminator network 132 during a training cycle. The discriminator network 132 may be trained in epochs of any suitable length, using any suitable number of words from the training data set 164 per epoch, and may be trained for two epochs for every single epoch for which the generator network 134 is trained.

The discriminator network 132 may be the subject of a hyperparameter search to discover the dimensions for the layers of the discriminator network 132. This may result in the training of multiple versions of the discriminator network with layers of varying dimensions using the training data set 164. Each version of the discriminator network may be initialized with weights that preserve variance before being trained.

FIG. 4B shows an example arrangement for training neural networks for name generation according to an implementation of the disclosed subject matter. After the discriminator network 132 has been trained, for example, for two epochs, the generator network 134 may be trained for one epoch. Random inputs, for example, random variates of a normal distribution, may be input to the generator network 134, which may output words. The random inputs may be, for example, vectors with any suitable number of elements with random or pseudorandom values. The words may be output in any suitable format, including, for example, in a feature vector format suitable for input to the discriminator network 132 and the NLP transformer network 139. The words output by the generator network 134 may be input to the NLP transformer network 139. The NLP transformer network 139 may determine which of the words match the selected options from the guiding metadata and output those words to the discriminator network 132. Words that match the selected options from the guiding metadata may be words which conform to the stylistic preferences of the user as indicated through the guiding metadata. For example, if the guiding metadata indicates that the words should sound “futuristic”, words that the NLP transformer network 139 determines to be “modern” or “past” may not be output to the discriminator network 132, as the NLP transformer network 139 may filter out any words output by the generator network 134 that do not have a “futuristic” style. The determinations made by the NLP transformer network 139 may be based on the NLP transformer network 139 classifying words received as input from the generator network 134 on the properties the NLP transformer network 139 was trained to perform classification on. The determinations made by the NLP transformer network 139 may be output to generator trainer 138 so that the generator trainer 136 may maintain a count of the number of words generated by the generator network 134 that did and did not match the guiding metadata.

The words output by the NLP transformer network 139, for example, the words generated by the generator network 134 that match the guiding metadata, may be input to the discriminator network 132. The discriminator network 132 may determine whether the input words are considered by the discriminator network 132 to belong to the target set 162, for example as a binary determination or a probability or confidence level.

The generator trainer 138 may use the determinations output from the discriminator network 132 and the NLP transformer to train the generator network 134. For example, the generator trainer 138 may use every word generated by the generator network 134 that either didn't match the guiding metadata or weren't determined to belong to the target set 162, in determining error of the generator network 134. The discriminator trainer 138 may also determine the error based on, for example, probabilities or confidence levels output by the discriminator network 132. The generator trainer 136 may adjust the weights of the generator network 134 in any suitable manner based on the determined error, or loss, of the generator network 134. This may train the generator network 134 to generate words that both match the guiding metadata and are suitable names for the object type that the name generator 130 will be used to generate names for, for example, words that the discriminator network 132 would determine belong to the target set 162 even through the words are not actually part of the target set 162. For example, if the name generator 130 will be used to generate the name for a research paper, the target set 162 may include gathered research paper names and the training of the generator network 134 using the discriminator network 132 and the NLP transformer network 139 may result in the generator network 134 being able to generate words that match the guiding metadata and would be suitable names for research papers, as opposed to names that would not be, such as words more suitable as business names. The training of the generator network 134 with the generator trainer 138 may use, for example, stochastic gradient descent, adaptive gradient algorithm, root mean square propagation, or Adam.

In some implementations, words may be input to the discriminator network 132 before being input to the NLP transformer network 139. For example, the discriminator network 132 may make a binary determination of which words output by the generator network 134 belong to the target set 162, and only those words considered to belong to the target set 162 may be input to the NLP transformer network 139 to determine if they match the guiding metadata. If the discriminator network 132 outputs probabilities or confidence levels, only those words above some probability or confidence level may be input to the NLP transformer network 139.

In some implementations, all words output by the generator network 134 may be input to both the discriminator network 132 and the NLP transformer network 139, regardless of any determinations made by the discriminator network 132 and the NLP transformer network 139.

The NLP transformer network 139 may allow the generator network 134 to be trained to generate words that both match the guiding metadata and can serve as an appropriate name for the object that the name generator 130 will be used to name without requiring that the words gathered for the target set 162 match the guiding metadata. This makes the gathering of the target set 162 and the training of the discriminator network 132 more efficient while still resulting in the generator network 134 generating words that match the guiding metadata and appear to be part of the target set 162.

Any number of random inputs may be input to the generator network 134 of the name generator 130 to train the generator network 134 during a training epoch for the generator network 134. The generator network 134 may be trained for one epoch for every two epochs the discriminator network 132 is trained for.

A training cycle for the name generator 130 may alternate between two epochs of training the discriminator network 132 and one epoch of training the generator network 134 any suitable number of times, and the end of the training cycle for the name generator 130 may be determined in any suitable manner. For example, training may continue until the discriminator network 132 achieves a threshold level of accuracy in its determinations of whether a word from the training data set 164 belongs to the target set 162 and a threshold percentage of words output by the generator network 134 are determined to both match the guiding metadata by the NLP transformer network 139 and be part of the target set 162 by the discriminator network 132.

The generator network 134 may be the subject of the same hyperparameter search as the discriminator network 132 to discover the dimensions for the layers of the generator network 134. This may result in the training of multiple versions of the generator network with layers of varying dimensions using versions of the discriminator network that have been trained on the training data set 164. Each version of the generator network may be initialized with weights that are orthogonal matrices.

The hyperparameter search may use any suitable number of sets of dimension sizes for the layers of the discriminator network 132 and the generator network 134. After the training cycles for each set of dimensions for the layers of the discriminator network 132 and the generator network 134 are completed, the best dimensions for the layers of the discriminator network 132 and the generator network 134 may be selected in any suitable manner. For example, the set of dimensions that result in the generator network that generates the highest percentage of words that both match the guiding metadata and are considered to belong to the target set 162 by the discriminator network with the dimensions the resulted in the highest accuracy on the training data set 164 may be selected as the best dimensions. The weights of the version of the generator network determined to have the best dimensions may be used along with those dimensions as the generator network 134 for the name generator 130.

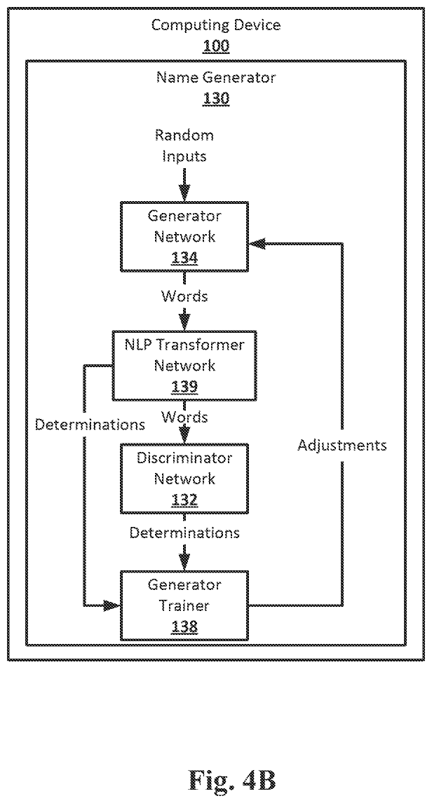

FIG. 5 shows an example arrangement for training neural networks for name generation according to an implementation of the disclosed subject matter. The name generator 130 may be used to generate words. The words output by the name generator 130 may be words that match the guiding metadata and appear to be from the target set 162, making the words appropriate names for an object of the object type that the name generator 130 is being used to generate a name for. To generate words, random input may be input to the generator network 134 which may then output a word. The generator network 134 may have a structure that uses layers with the dimensions that were determined to be the best dimensions during the hyperparameter search along with the weights for those layers that resulted from training that version of the generator network that had the best dimensions. The random inputs may be, for example, vectors that are random variates of a normal distribution. Any number of random inputs may be used as input to the generator network 134, resulting in the generation of any number of words. The words generated by the generator network 134 may be output from the name generator 130. The words may be output in any suitable manner. For example, the words may be output to a display of the computing device 100 or the display of another computing device, may be transmitted as an electronic message such as an email, or may be presented to a user in any other suitable manner so that the user may select a name for the object from among the words. If the user does not find any of the words acceptable as a name for the object, the user may have the name generator 130, including the generator network 134 and the discriminator network 132, retrained, for example, continuing the hyperparameter search with previously untried sets of dimensions or having the target set gatherer 110 gather additional words for the target set 162.

The generator network 134, using the dimensions and weights of the best version of the generator network from the hyperparameter search, may only be used to generate words for the received object type and guiding metadata. To generate words that may be used to name an object of a different type, or an object of the same type with different guiding metadata, a new training set may be needed, and a new hyperparameter search may be initiated to generate a new generator network.

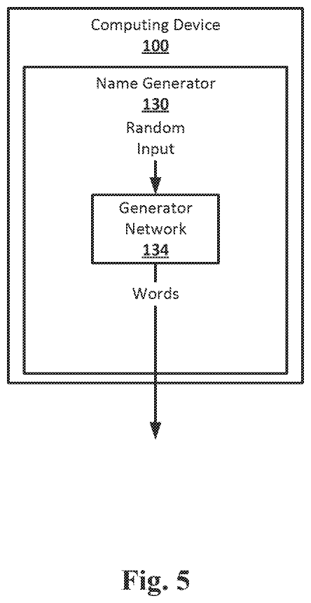

FIG. 6 shows an example procedure suitable for training neural networks for name generation according to an implementation of the disclosed subject matter. At 602, an object type and guiding metadata may be received. For example, the object type and guiding metadata may be received at the computing device 100. The object type and guiding metadata may be received as input from, for example, a user. The object type may indicate the type of the object that the words generated by the name generator 130 will be potential names for. The guiding metadata may indicate additional criteria that the words generated by the name generator 130 should match in addition to appearing to be appropriate names for an object of the object type. The guiding metadata may be based on, for example, the properties of words on which the NLP transformer 120 is trained to perform classification and may include selected options for any number of those properties.

At 604, words may be received. For example, the target set gatherer 110 may access websites on the Internet and obtain words by scraping and performing named entity recognition. The words obtained by the target set gatherer 110 may be received at the computing device 100. The words obtained by the target set gatherer 110 may be words that are actual names for objects of the received object type. For example, if the received object type is “startup technology business”, the target set gatherer 110 may obtain words that are already names for existing startup technology businesses. The websites accessed by the target set gatherer 110 and from which words may be obtained may be, for example, based on the received object type, and may be websites that include actual names for objects of the received object type. For example, websites that belong to businesses or are businesses directories or listings may be used to obtain words when the object type is “business”, while websites that host or index research papers may be used to obtain words when the object type is “research paper”. This may result in the target set 162 that results from the words gathered by the target set gatherer 110 including words that are already used to name objects whose object type is the same as the received object type. The target set gatherer 110 may obtain any suitable number of words. Each time the computing device 100 receives an object type, for example, as user input, the target set gatherer 110 may gather words based on that object type. In some implementations, a target set may be reused when a subsequent received object type is the same as a previously received object type.

At 606, the words may be stored as a target set. For example, the words obtained by the target set gatherer 110 may be stored in the storage 160 of the computing device 100 as the target set 162. The target set 162 may be specific to the received object type.

At 608, a training data set may be generated. For example, the target set 162 may be used to generate the training data set 164. The training data set 164 may include the words from the target set 162, which may be actual names for objects of the received object type, as positive examples, and words that are both not in the target set 162 and would not belong in the target set 162, for example, words that are actual names of objects that are of object types that are not the received object type, as negative examples. An answer key may indicate which words in the training data set 164 are positive examples and which are negative examples. For example, if the target set 162 includes names for a startup technology business, the negative examples in the training data set 164 that includes the target set 162 may be words names for objects that are not startup technology businesses. The training data set 164 may be stored in the storage 160 of the computing device 100.

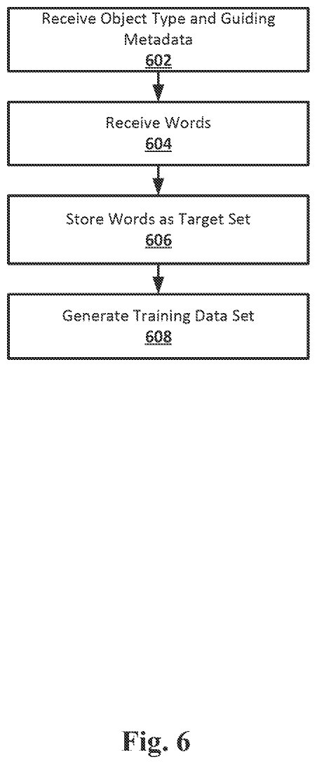

FIG. 7 shows an example procedure suitable for training neural networks for name generation according to an implementation of the disclosed subject matter. At 702, a hyperparameter search may be initiated. The hyperparameter search may, for example, be initiated to use suitable number of different sets of dimensions for the discriminator network 132 and the generator network 134. Each set of dimensions may include dimensions for the layers of the discriminator network 132 and dimensions for the layers of the generator network 134. The hyperparameter search may entail training versions of the discriminator network 132 and the generator network 134 using each set of dimensions that the hyperparameter search was initiated with to determine which set of dimensions results in the best generator network 134.

At 704, a discriminator network may be initialized. For example, the discriminator network 132 of the name generator 130 may be initialized with dimensions from one of the sets of dimensions being used in the hyperparameter search. The discriminator network 132 may be initialized with weights that preserve variance, for example, random weights.

At 706, a generator network may be initialized. For example, the generator network 134 of the name generator 130 may be initialized with dimensions from one of the sets of dimensions being used in the hyperparameter search. The generator network 134 may be initialized with weights that are orthogonal matrices.

At 708, a word from a training data set may be received as input at the discriminator network. For example, the discriminator network 132 of the name generator 130 may receive a word from the training data set 164. The word may be received in any suitable format, such as, for example, as a feature vector. The word may be selected from the training data set 164 in any suitable manner, including, for example, at random.

At 710, a determination may be generated with the discriminator network. For example, the discriminator network 132 may generate a determination based on the word from the training data set 164 input to the discriminator network 132. The determination may be, for example, a binary indicator or a probability of confidence level, and may be an estimate of whether the input word from the training data set 164 belongs to the target set 162.

At 712, the discriminator network may be adjusted. For example, the discriminator trainer 136 may, using an answer key from the training data set 164, determine the correctness of the determination output by the discriminator network 132. The level of correctness or incorrectness of the discriminator network 132 may be used by the discriminator network 136 to make adjustments to the discriminator network 132. The adjustments may be, for example, adjustments to the weights of the discriminator network 132. For example, if the discriminator network 132 determined that an input word did not belong to the target set 162 when the input word did belong to the target set 162, the discriminator trainer 136 may determine that the discriminator network 132 was incorrect and may adjust the weights of the discriminator network 132 according to the level of incorrectness. The level of incorrectness may be based in part on whether the discriminator network 132 outputs binary determination or probability or confidence levels. The adjustments may be applied in any suitable manner, such as, for example, using stochastic gradient descent, adaptive gradient algorithm, root mean square propagation, or Adam.

At 714, if two training epochs for the discriminator network are complete, the flow may proceed to 716. Otherwise, flow may proceed back to 708, where another word from the training data set may be received as input at the discriminator network. The completion of a single training epoch for the discriminator network 132 may be determined based on any suitable criteria, such as, for example, the discriminator network 132 being trained for a set period of time, or being trained with a set number of words from the training data set 164.

At 716, a random input may be received at a generator network. For example, the generator network 134 of the name generator 130 may receive a random input, which may be, for example, a random variate of a normal distribution. The random input may be in any suitable format, such as, for example, a vector or matrix format.

At 718, a word may be generated with the generator network. For example, the generator network 134 may generate a word based on the random input. The word may be output from the generator network 134 in any suitable format, including, for example, as a feature vector that may be suitable for input to the discriminator network 132.

At 720, the word may be received at an NLP transformer. For example, the word generated and output by the generator network 134 may be input to the NLP transformer network 139.

At 722, if the word matches the guiding metadata, flow may proceed to 724, where the word may be received at the discriminator network. Otherwise, flow may proceed to 728, where the generator network may be adjusted. The NLP transformer network 139 may determine whether the word generated by the generator network 134 matches guiding metadata that was received along with the object type that was used to obtain words for the target set 162. If the word matches the guiding metadata, then it may be input to the discriminator network 132. Otherwise, if the word does not match the guiding metadata, the word may not need to be input to the discriminator network 132. The NLP transformer network 139 may determine whether the word matches the guiding metadata in any suitable manner. For example, the guiding metadata may indicate criteria for properties of the word based on properties that the NLP transformer network 139 can classify. The NLP transformer network 139 may classify the word on each of the properties in the guiding metadata, and these classifications may be compared to the guiding metadata. The word may need to match all of the guiding metadata for flow to proceed to 724. For example, if the guiding metadata includes criteria for four different properties and the classification performed by the NLP transformer network 139 indicates that the word only matches the criteria for three of those properties, flow may proceed to 728.

At 724, the word may be received at the discriminator network. For example, the word generated and output by the generator network 134 and determined to match the guiding metadata by the NLP transformer network 139 may be input to the discriminator network 132.

At 726, a determination may be generated with the discriminator network. For example, the discriminator network 132 may generate a determination based on the word input generated by the generator network 134 and input to the discriminator network 132. The determination may be, for example, a binary indicator or a probability of confidence level, and may be an estimate of whether the word generated by the generator network 134 belongs to the target set 162.

At 728, adjustments may be made to the generator network. For example, the generator trainer 138 may determine adjustments to be made to the generator network 134 based on whether the word generated by the generator network 134 matched the guiding metadata, as determined by the NLP transformer network 139, and if the word did match the guiding metadata, whether the word was considered by the discriminator network 134 to belong to the target set 162 even though the word is not actually part of the target set 162. The generator trainer 138 may determine that the word output by the generator network 134 is correct when the word both matched the guiding metadata and was considered to belong to the target set 162. Otherwise, the generator trainer 138 may determine some level of incorrectness of the generator network 134 if the word did not match the guiding metadata or matched the guiding metadata but was not considered to belong to the target set 162. The adjustments may be, for example, adjustments to the weights of the generator network 134. The adjustments may be applied in any suitable manner, such as, for example, using stochastic gradient descent, adaptive gradient algorithm, root mean square propagation, or Adam.

At 730, if one training epoch for the generator network is complete, the flow may proceed to 732. Otherwise, flow may proceed back to 716, where another random input may be received at the generator network. One training epoch for the generator network 134 may be determined to be complete based on any suitable criteria, such as, for example, the generator network 134 being trained for a set period of time, or generating a set number of words that are input to the NLP transformer network 139.

At 732, if the training cycle for the name generator is complete, the flow may proceed to 734. Otherwise, flow may proceed back to 708, where another word from the training data set may be received and another training epoch for the discriminator network 132 may be started. The training cycle for the name generator 130 may be determined to be complete based on any suitable criteria, such as, for example, the completion of a set number of training epochs of both the discriminator network 132 and the generator network 134, or the achievement of both a threshold level of accuracy by the discriminator network 132 and a threshold percentage of words output by the generator network 134 being determined by the NLP transformer network 139 to match the guiding metadata by the discriminator network 132 to be words that belong to the target set 162.

At 734, if the hyperparameter search is complete, flow may proceed to 736. Otherwise, if the hyperparameter search is not complete, flow may proceed back to 704 where dimensions from a previously unused set of dimensions may be used to initialize a discriminator network and a generator network. The hyperparameter search may generate and train any number of versions of the discriminator network 132 and the generator network 134 using the sets of dimensions for the hyperparameter search. In some implementations, the different versions of the discriminator network 132 and the generator network 134 may be trained fully or partially in parallel rather than wholly iteratively.

At 736, the best generator network parameters may be determined. For example, the best parameters, including dimensions and weights, for the generator network 134 may be determined based on which set of dimensions in the hyperparameter search resulted in the highest combined accuracy of the discriminator network 132 in determining whether words belong to the target set 162 and ability of the generator network 134 to generate words that both matched the guiding metadata and were considered by the discriminator network 132 to belong to the target set 162. The generator network 134 that uses the best parameters from the hyperparameter search may be specific to the object type and the guiding metadata that were received as input before the hyperparameter search and were used to gather words for the target set 162 and by the NLP transformer network 139 during the hyperparameter search. A new hyperparameter search may be initiated for each input of an object type and guiding metadata, resulting in new versions of the generator network 134 for each distinct combination of object type and guiding metadata. In some implementations, a version of the generator network 134 that resulted from a hyperparameter search for a specified object type and with specified guiding metadata may be reused when that specified object type and specified guiding metadata are input in the future.

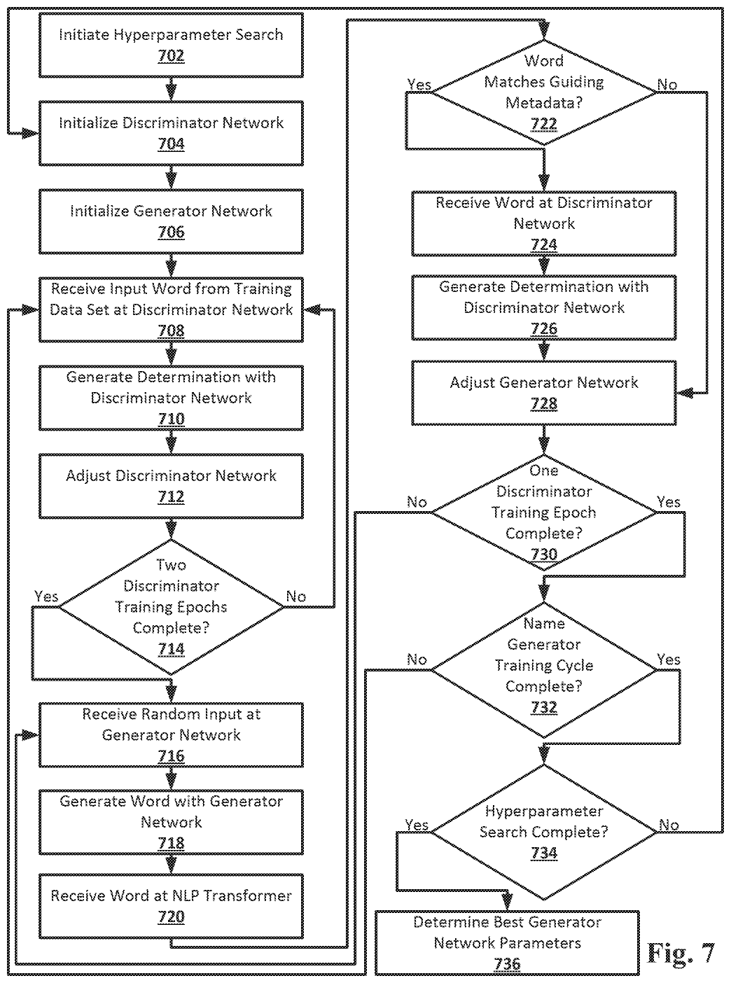

FIG. 8 shows an example procedure suitable for training neural networks for name generation according to an implementation of the disclosed subject matter. At 802, words may be generated. For example, the name generator 130 may generate words. The words may be generated in any suitable format. The words may be generated by, for example, inputting a random variate of a normal distribution or other random input to the generator network 134 of the name generator 130. The generator network 134 may use the dimensions and weights that were determined to be the best version of the generator network 134 from all versions trained during the hyperparameter search. For each input, the generator network 134 may generate a word.

At 804, words may be output. For example, the words generated by the name generator 134 may be output from the name generator 130. The words may be output in any suitable manner. For example, the words may be displayed on a display device that is in communication with the computing device 100 as part of a displayed user interface for the name generator 130. The words may also be output as an electronic communication, for example, email, SMS message, MMS message, stored in a document on a cloud computing server system, or presented to a user in any other suitable manner. If a user does not find a suitable name for their object from among the words output by the name generator 130, the user may be able to cause the generator network 134 to continue generating words until the user considers one of the words to be a suitable name for their object. The user may also be able to cause the hyperparameter search to be restarted using different dimensions, resulting in a new generator network 134 being generated.

Implementations of the presently disclosed subject matter may be implemented in and used with a variety of component and network architectures. FIG. 9 is an example computer 20 suitable for implementing implementations of the presently disclosed subject matter. As discussed in further detail herein, the computer 20 may be a single computer in a network of multiple computers. As shown in FIG. 9, computer may communicate a central component 30 (e.g., server, cloud server, database, etc.). The central component 30 may communicate with one or more other computers such as the second computer 31. According to this implementation, the information obtained to and/or from a central component 30 may be isolated for each computer such that computer 20 may not share information with computer 31. Alternatively or in addition, computer 20 may communicate directly with the second computer 31.

The computer (e.g., user computer, enterprise computer, etc.) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 enable data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

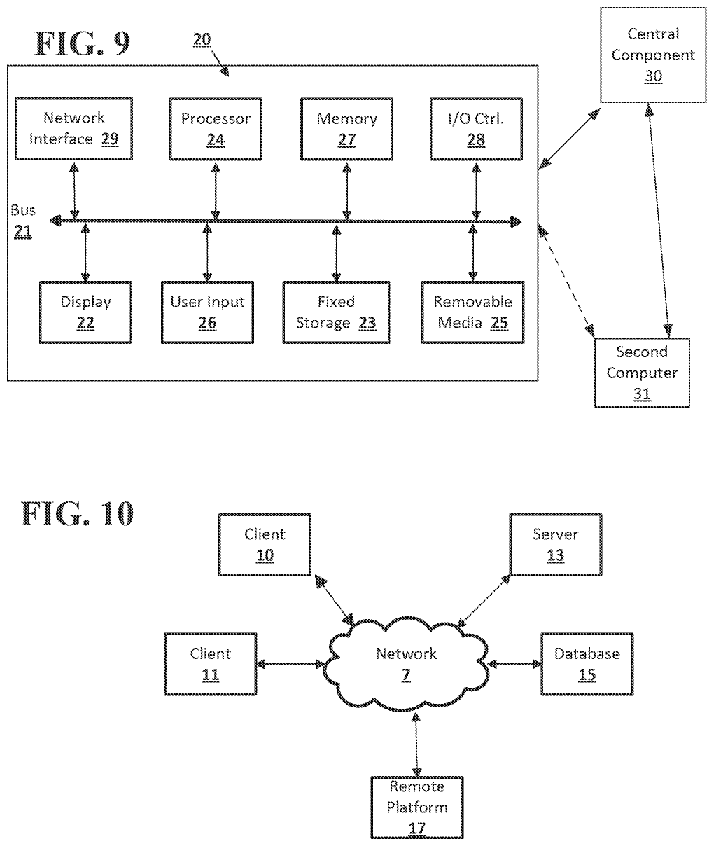

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may enable the computer to communicate with other computers via one or more local, wide-area, or other networks, as shown in FIG. 10.

Many other devices or components (not shown) may be connected in a similar manner (e.g., document scanners, digital cameras and so on). Conversely, all of the components shown in FIG. 9 need not be present to practice the present disclosure. The components can be interconnected in different ways from that shown. The operation of a computer such as that shown in FIG. 9 is readily known in the art and is not discussed in detail in this application. Code to implement the present disclosure can be stored in computer-readable storage media such as one or more of the memory 27, fixed storage 23, removable media 25, or on a remote storage location.

FIG. 10 shows an example network arrangement according to an implementation of the disclosed subject matter. One or more clients 10, 11, such as computers, microcomputers, local computers, smart phones, tablet computing devices, enterprise devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. Information from or about a first client may be isolated to that client such that, for example, information about client 10 may not be shared with client 11. Alternatively, information from or about a first client may be anonymized prior to being shared with another client. For example, any client identification information about client 10 may be removed from information provided to client 11 that pertains to client 10.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented comprising:
receiving a target set comprising words associated with an object type;
training a discriminator network and a generator network, wherein the discriminator network is trained with a training data set that is based on the target set and the generator network is trained with random inputs and the discriminator network, and wherein the discriminator network is trained for two epochs for each epoch for which the generator network is trained; and
generating, with the generator network, words.

2. The computer-implemented method of claim 1, further comprising:
receiving guiding metadata; and
during training of the discriminator network and the generator network, using the guiding metadata in the training of the generator network.

3. The computer-implemented method of claim 2, wherein using the guiding metadata in the training of the generator network further comprises determining with an NLP transformer network whether words output by the generator network during the training of the generator network match the guiding metadata.

4. The computer-implemented method of claim 2, wherein the guiding metadata comprises options selected for properties of words.

5. The computer-implemented method of claim 1, further comprising:
receiving an indication of the object type;
gathering the words associated with the object type from one or more websites associated with objects of the object type; and
generating the target set from the gathered words associated with the object type.

6. The computer-implemented method of claim 1, wherein training the discriminator network and the generator network further comprises initiating a hyperparameter search that uses sets of dimensions for the generator network and the discriminator network.

7. The computer-implemented method of claim 1, further comprising, before training the discriminator network and the generator network:
initializing the discriminator network with weights that preserve variance; and
initializing the generator network with weights that are orthogonal matrices.

8. A computer-implemented system for training neural networks for name generation comprising:
one or more storage devices; and
a processor that receives a target set comprising words associated with an object type,
trains a discriminator network and a generator network, wherein the discriminator network is trained with a training data set that is based on the target set and the generator network is trained with random inputs and the discriminator network, and wherein the discriminator network is trained for two epochs for each epoch for which the generator network is trained, and
generates, with the generator network, words.

9. The computer-implemented system of claim 8, wherein the processor further receives guiding metadata, and during training of the discriminator network and the generator network, uses the guiding metadata in the training of the generator network.

10. The computer-implemented system of claim 9, wherein the processor uses the guiding metadata in the training of the generator network further by determining with an NLP transformer network whether words output by the generator network during the training of the generator network match the guiding metadata.

11. The computer-implemented system of claim 9, wherein the guiding metadata comprises options selected for properties of words.

12. The computer-implemented system of claim 8, wherein the processor further receives an indication of the object type,
gathers the words associated with the object type from one or more websites associated with objects of the object type, and
generates the target set from the gathered words associated with the object type.

13. The computer-implemented system of claim 8, wherein the processor trains the discriminator network and the generator network by initiating a hyperparameter search that uses sets of dimensions for the generator network and the discriminator network.

14. The computer-implemented system of claim 8, wherein the processor further, before training the discriminator network and the generator network, initializes the discriminator network with weights that preserve variance and initializes the generator network with weights that are orthogonal matrices.

15. A system comprising: one or more computers and one or more storage devices storing instructions which are operable, when executed by the one or more computers, to cause the one or more computers to perform operations comprising:
receiving a target set comprising words associated with an object type;
training a discriminator network and a generator network, wherein the discriminator network is trained with a training data set that is based on the target set and the generator network is trained with random inputs and the discriminator network, and wherein the discriminator network is trained for two epochs for each epoch for which the generator network is trained; and
generating, with the generator network, words.

16. The system of claim 15, wherein the instructions further cause the one or more computers to perform operations comprising:
receiving guiding metadata; and
during training of the discriminator network and the generator network, using the guiding metadata in the training of the generator network.

17. The system of claim 16, wherein the instructions cause the one or more computers to perform the operation of using the guiding metadata in the training of the generator network further by determining with an NLP transformer network whether words output by the generator network during the training of the generator network match the guiding metadata.

18. The system of claim 16, wherein the guiding metadata comprises options selected for properties of words.

19. The system of claim 15, wherein the instructions further cause the one or more computers to perform operations comprising:
receiving an indication of the object type;
gathering the words associated with the object type from one or more websites associated with objects of the object type; and
generating the target set from the gathered words associated with the object type.

20. The system of claim 15, wherein the instructions cause the one or more computers to perform the operation of training the discriminator network and the generator network by initiating a hyperparameter search that uses sets of dimensions for the generator network and the discriminator network.
